(19) United States
(12) Patent Application Publication
(10) Pub. No.: US 2011/0069481 A1
(43) Pub. Date: Mar. 24, 2011

(54) Sunglass holder detachably attached with illuminator

(76) Inventor: Mike Chen, Hsin-Ten (TW)

(21) Appl. No.: 12/586,503

(22) Filed: Sep. 24, 2009

(51) Int. Cl. F21L 4/00; B60R 7/00; B60Q 3/02; F21V 21/096

(52) U.S. Cl. 362/191; 224/400; 362/549

(57) ABSTRACT

A sunglass holder is removably clamped on a sunvisor in a car for fastening a pair of sunglasses or eyeglasses on the sunglass holder when not in use, and an illuminator such as a LED illuminator is detachably attached to the sunglass holder. The illuminator may be easily removed from the sunglass holder for portable illumination use.

### BACKGROUND OF THE INVENTION

U.S. Pat. No. 4,715,575 disclosed an eyeglass holder including a backing plate affixed to a support structure such as sunvisor of a car, and a clamping finger pivotally attached to the backing plate, whereby when not in use, a pair of sunglasses may be held in between the clamping finger and the backing plate for storage of the eyeglasses.

However, the full set of sunglasses, including the pair of lenses, the bridge portion between the lenses, and the folded temples, should be overall clamped in the holder, thereby pressurizing the central portion of the sunglasses to easily cause deformation of the sunglasses.

Meanwhile, there is no prior art disclosing a miniature illuminator or flashlight which is normally held or clamped on a sunvisor in a car, and will be easily detached from the sunvisor for portable illumination when required.

The present inventor has found the drawbacks of the prior art and invented the present sunglass holder detachably attached with an illuminator on the holder.

### SUMMARY OF THE INVENTION

The object of the present invention is to provide a sunglass holder which is detachably clamped on a sunvisor in a car for fastening a pair of sunglasses or eyeglasses on the holder when not in use, and an illuminator such as a LED illuminator detachably attached on the sunglass holder and easily removed from the holder for portable illumination use.

### BRIEF DESCRIPTION OF THE DRAWINGS

FIG. 1 is an exploded view showing the parts of the present invention.

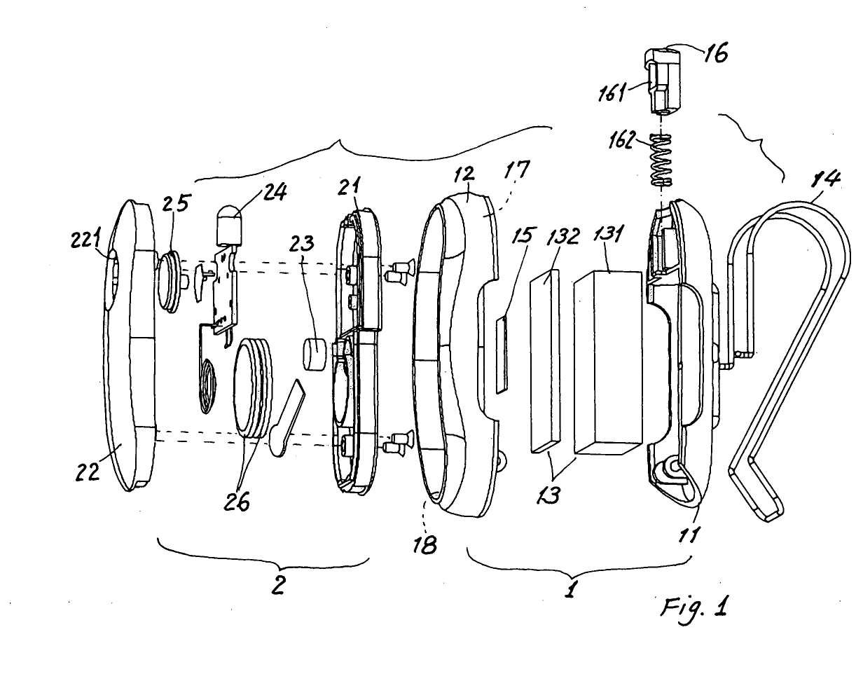

FIG. 2 is a longitudinal sectional drawing of the present invention fastened to a sunvisor and having a pair of sunglasses clamped thereon.

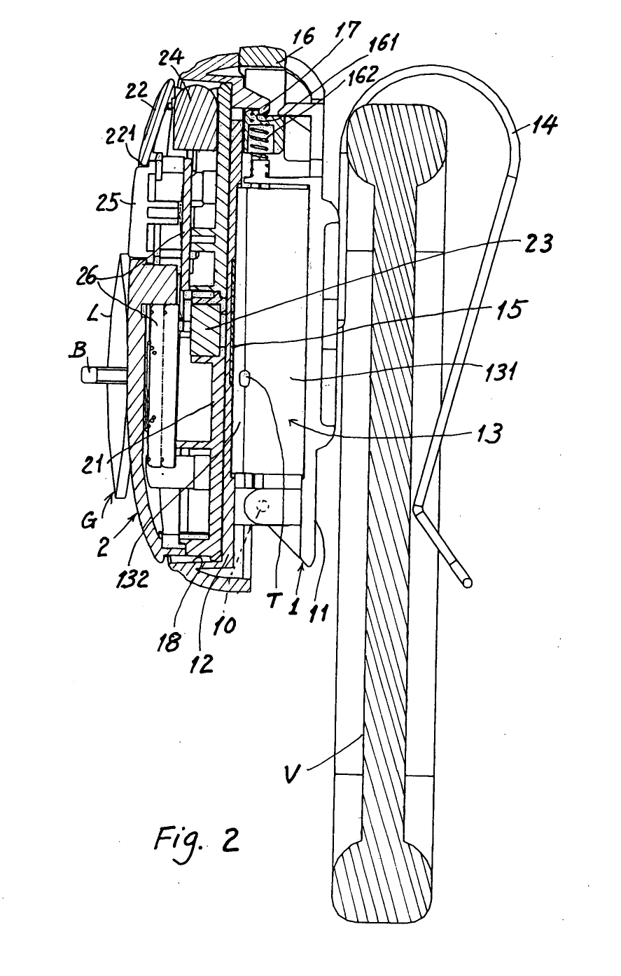

FIG. 3 is a front view illustration of the present invention when fastened on a sunvisor and having a pair of sunglasses clamped thereon.

FIG. 4 is a perspective view of the present invention.

FIG. 5 is an illustration of the present invention when opening the holder for removing sunglasses therefrom or for inserting sunglasses therein.

FIG. 6 shows an illuminator detached from the holder in accordance with the present invention.

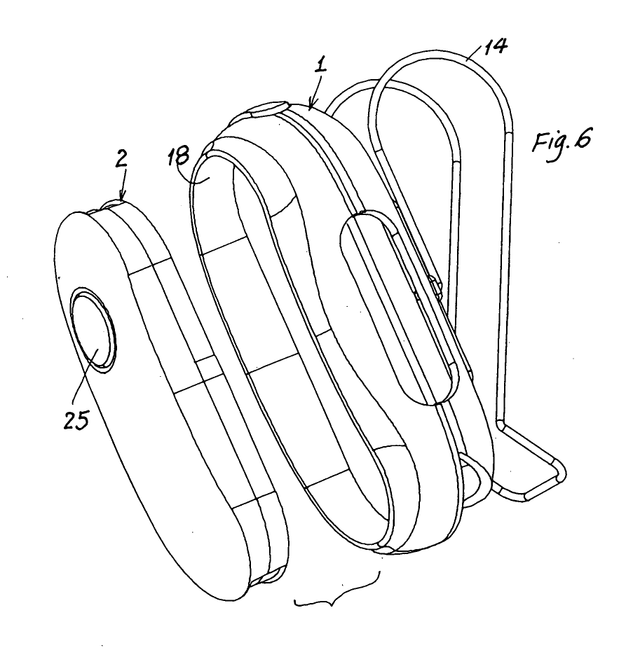

### DETAILED DESCRIPTION

As shown in the drawing figures, the present invention comprises: a sunglass holder 1 removably clamped on a sunvisor V in a car for clamping a pair of sunglasses or eyeglasses G thereon; and an illuminator 2 detachably attached on the sunglass holder 1.

The sunglass holder 1 includes: a base shell 11 removably clipped on a sunvisor V or a fixture in a car, and a clamping shell 12 pivotally secured to the base shell 11 by a hinge or pivoting means 10 for clamping a pair of sunglasses G in between the base shell 11 and the clamping shell 12 when not in use.

A soft packing member 13 includes an inner pad 131 secured to the base shell 11 and an outer pad 132 secured to the clamping shell 12 for resiliently clamping a pair of folded temples T of the sunglasses G in between the inner pad 131 and the outer pad 132. The packing member 13 may be made of sponge, foam or elastomers.

The base shell 11 includes a clip 14 formed on a back portion of the shell 11 to be removably clipped on the sunvisor V in a car.

A ferrous or iron plate 15 is adhered or fixed in the clamping shell 12 for magnetically attracting the illuminator 2 having a magnet 23 mounted in the illuminator 2 for detachably attaching the illuminator 2 on the sunglass holder 1.

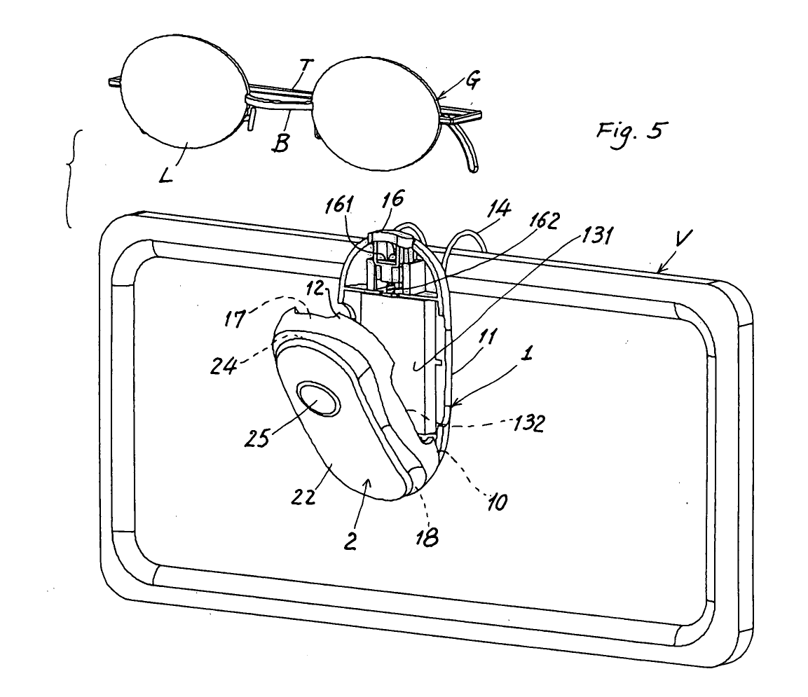

A control button 16 is resiliently formed on an upper (or outer) portion of the base shell 11, having a locking portion 161 formed in the control button 16 and a tensioning spring 162 retained in the base shell 11 for normally urging the control button 16 upwardly or outwardly; and a latch member 17 is formed in the clamping shell 12 for engaging the locking portion 161 of the control button 16 for closing the clamping shell 12 to the base shell 11 for clamping a pair of folded temples T of the sunglass G in between the base shell 11 and the clamping shell 12, and whereby upon depression of the control button 16 to disengage the latch member 17 from the locking portion 161 of the control button 16, the clamping shell 12 will be pivotally opened (FIG. 5) for removing the sunglasses G from the holder 1 or for inserting the sunglasses G into the holder 1.

The illuminator 2 includes a lamp 24 electrically connected to a power supply device 26 mounted in the illuminator 2, a magnet 23 secured in the illuminator 2 to be magnetically attracted to the ferrous plate 15 fixed in the sunglass holder 1, and a switch button 25 resiliently formed on the illuminator 2 for switching on or off the lamp 24. The illuminator 2 is detachably held in a recess 18 as recessed in the sunglass holder 1 and is magnetically attracted to the sunglass holder 1 by a magnetic attraction between the magnet 23 in the illuminator 2 and the ferrous plate 15 in the sunglass holder 1, whereby upon separation of the illuminator 2 from the sunglass holder 1 by overcoming the magnetic attraction therebetween, the illuminator 2 may be removed from the sunglass holder for a convenient portable illumination use in the car or in a dark surrounding. So, the magnet 23 and the ferrous plate 15 may be deemed as a “fastening means” for fastening the illuminator 2 on the holder 1.

Of course, the illuminator 2 may also be detachably attached to the sunglass holder 1 by any other fastening means, not limited in this invention.

The illuminator 2 includes a bottom cover 21 having the magnet 23 mounted on an inside surface (or portion) of the bottom cover 21 to be magnetically attracted to the ferrous plate 15 mounted in the clamping shell 12 of the sunglass holder 1, and an outer cover 22 combinably fixed to the bottom cover 21 for encasing the power supply device 26 in between the bottom cover 21 and the outer cover 22.

The power supply device 26 may include at least a battery (or button cell) electrically connected to a circuit board secured to the bottom cover 21, and the switch button 25 resiliently protruded through a button hole 221 formed in the outer cover 22 and electrically connected to the power supply device 26 for connecting or disconnecting the power supply to the lamp 24 for switching on or off the lamp 24.

The lamp 24 may be a bulb or a LED lamp, not limited in this invention.

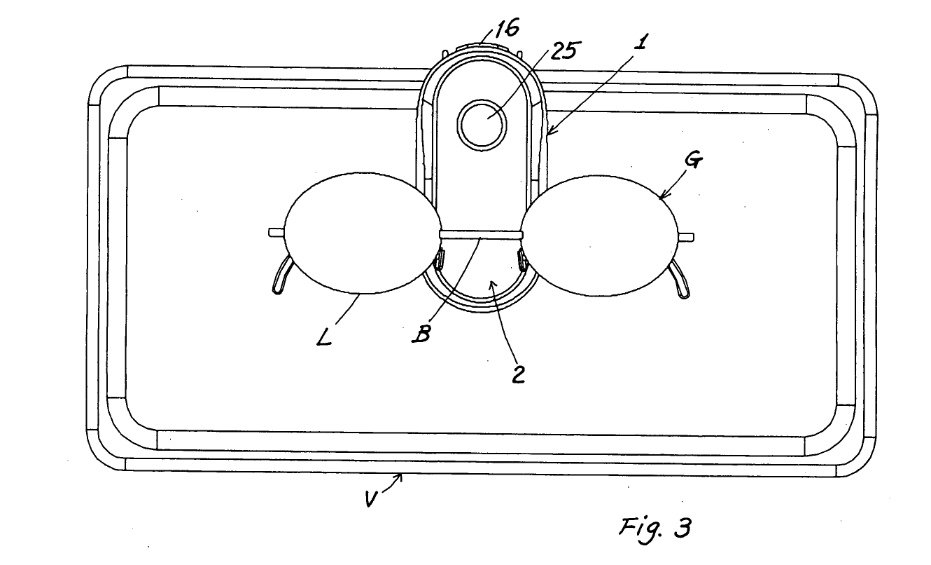

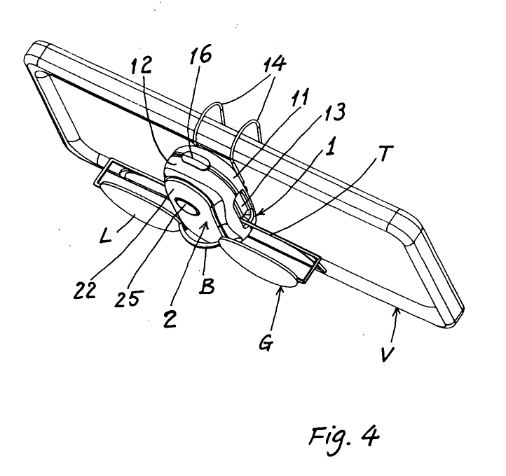

When not in use, the folded temples 5 of the sunglasses G may be inserted and clamped in between the clamping shell 12 and the base shell 11 of the sunglass holder 1 as shown in FIGS. 3, 4 to allow the pair of lenses L and their bridge portion B to be positioned in front of the illuminator 2.

When it is intended for use, the button 16 may be depressed to disengage (or open) the clamping shell 12 from the base shell 11, the sunglasses may then be removed for wearing.

When it is dark or at night time, the illuminator 2 may be easily removed from the sunglass holder 1 just by simply overcoming the “small” magnetic attraction force between the magnet 23 in the illuminator 2 and the ferrous plate 15 in the sunglass holder 1. Therefore, the illuminator 2 may serve as a portable flashlight for a convenient illumination in a car or in any location.

The present invention provides a sunglass holder for removably storing a pair of sunglasses thereon, and an illuminator 2 detachably carried on the sunglass holder 1 for a convenient storing of the illuminator 2.

The sunglass holder 1 plays a double duty, namely for clamping the sunglasses when not in use without occupying a big volume in a car, and also for “storing” an illuminator 2 on the holder 1 to prevent from loss on missing of the illuminator 2, but to quickly “find out” the illuminator 2 especially when required for illumination or emergency use in night time.

The sunglass holder 1 may also be fastened or clipped to any other structures or fixtures in a car or in any other places.

The present invention may be modified without departing from the spirit and scope of the present invention.

I claim:

1. A sunglass holder comprising:
a base shell removably fastened or clipped on a sunvisor in a car or on a fixture;
a clamping shell pivotally secured to said base shell, and operatively closed to said base shell for clamping a pair of sunglasses in between said base shell and said clamping shell; and
an illuminator detachably attached in said clamping shell, whereby upon removal of said illuminator from said clamping shell, the illuminator is ready for portable illumination.

2. A sunglass holder according to claim 1, wherein said sunglass holder includes said clamping shell pivotally secured to the base shell by a hinge means for clamping a pair of sunglasses in between the base shell and the clamping shell when not in use.

3. A sunglass holder according to claim 1, wherein said base shell includes an inner pad secured to the base shell; and said clamping shell having an outer pad secured to the clamping shell for resiliently clamping a pair of folded temples of the sunglasses in between the inner pad and the outer pad.

4. A sunglass holder according to claim 1, wherein said base shell includes a clip formed on a back portion of the shell to be removably clipped on the sunvisor in a car.

5. A sunglass holder according to claim 1, wherein said clamping shell includes a ferrous plate adhered or fixed in the clamping shell for magnetically attracting the illuminator having a magnet mounted in the illuminator for detachably attaching the illuminator on the sunglass holder.

6. A sunglass holder according to claim 1, wherein said clamping shell includes a control button resiliently formed on an upper or outer portion of the base shell, having a locking portion formed in the control button and a tensioning spring retained in the base shell for normally urging the control button upwardly or outwardly; and a latch member formed in the clamping shell for engaging the locking portion of the control button for closing the clamping shell to the base shell for clamping a pair of folded temples of the sunglasses in between the base shell and the clamping shell, and whereby upon depression of the control button to disengage the latch member from the locking portion of the control button, the clamping shell will be pivotally opened for removing the sunglasses from the sunglass holder.

7. A sunglass holder according to claim 1, wherein said illuminator includes a lamp electrically connected to a power supply device mounted in the illuminator, a magnet secured in the illuminator to be magnetically attracted to a ferrous plate fixed in the sunglass holder, and a switch button resiliently formed on the illuminator for switching on or off the lamp; and said illuminator detachably held in a recess as recessed in the sunglass holder and magnetically attracted to the sunglass holder by a magnetic attraction between the magnet in the illuminator and the ferrous plate in the sunglass holder, whereby upon separation of the illuminator from the sunglass holder by overcoming a magnetic attraction between said magnet and said ferrous plate, the illuminator will be removed from the sunglass holder for a portable illumination.

8. A sunglass holder according to claim 7, wherein said illuminator includes a bottom cover having the magnet mounted in the bottom cover to be magnetically attracted to the ferrous plate mounted in the clamping shell of the sunglass holder, and an outer cover combinably fixed to the bottom cover for encasing the power supply device in between the bottom cover and the outer cover.

9. A sunglass holder according to claim 8, wherein said power supply device includes at least a battery electrically connected to a circuit board secured to the bottom cover, and the switch button resiliently protruded through a button hole formed in the outer cover and electrically connected to the power supply device for connecting or disconnecting the power supply to the lamp for switching on or off the lamp.

10. A sunglass holder according to claim 7, wherein said lamp is a LED lamp or a bulb.
